(19) United States
(12) Patent Application Publication
(10) Pub. No.: US 2012/0162388 A1
(43) Pub. Date: Jun. 28, 2012

(54) Image capturing device and image capturing control method

(75) Inventor: Teruyuki Sato, Kawasaki (JP)

(73) Assignee: FUJITSU LIMITED, Kawasaki (JP)

(21) Appl. No.: 13/200,364

(22) Filed: Sep. 23, 2011

(30) Foreign Application Priority Data
Dec. 22, 2010 (JP) 2010-286717

(51) Int. Cl. H04N 13/02

(52) U.S. Cl. 348/49; 348/E13.074

(57) ABSTRACT

An image capturing device includes a storage part containing parallax information having the amount of parallax of a first lens and a second lens correlated with the amount of first control for driving the first lens; a first focusing control part configured to control driving of the first lens to focus the first lens at a first detection position; a parallax compensation part configured to obtain, from the parallax information, the amount of parallax corresponding to the amount of the first control performed by the first focusing control part to cause the first lens to be focused, and to detect a second detection position obtained by reflecting the amount of parallax in the first detection position; and a second focusing control part configured to control driving of the second lens to cause the second lens to be focused at the second detection position detected by the parallax compensation part.

### CROSS-REFERENCE TO RELATED APPLICATION

This application is based upon and claims the benefit of priority of the prior Japanese Patent Application No. 2010-286717, filed on Dec. 22, 2010, the entire contents of which are incorporated herein by reference.

### FIELD

A certain aspect of the embodiments discussed herein is related to an image capturing device and an image capturing control method.

### BACKGROUND

In order to obtain a stereoscopic image using binocular parallax (or binocular disparity), an image is captured using a binocular camera, which is a single camera provided with two optical systems. However, in the case of inputting an image through multiple detection lenses, the detection lenses may be individually focused somewhere on an object but are not necessarily focused on the same point.

In particular, in the case of capturing an image in a closeup mode or with zooming using the binocular camera, a focus mismatch increases between the images of both eyes because of misfocusing due to lack of accuracy in camera control for each eye. Accordingly, the same point in the images captured with the individual cameras (optical systems) may be blurred differently.

FIG. 1 is a diagram for illustrating a focus mismatch between the images of both eyes. For simplification, the case illustrated in FIG. 1 is described with a camera 11 for the right eye and a cameral 12 for the left eye being separate bodies. The same thing, however, could occur in the binocular camera.

Referring to FIG. 1, the right-eye camera 11 is focused on a circular cone 3 on the near side. Further, the right-eye camera 11 is not focused on a rectangular parallelepiped 1 on the far side or a circular column 2 in the center, so that the rectangular parallelepiped 1 and the circular column 2 look blurry on a display part.

On the other hand, the left-eye camera 12 is focused on the circular column 2 in the center. Further, the left-eye camera 12 is not focused on the circular cone 3 on the near side or the rectangular parallelepiped 1 on the far side, so that the circular cone 3 and the rectangular parallelepiped 1 look blurry on the display part.

In order to solve this problem, a technique is proposed that provides the binocular camera with a separate distance measuring sensor and controls the focusing of cameras based on information on the distance measured with this distance measuring sensor. This distance measuring system is, for example, a so-called active distance measuring system, which exposes an object to light and measures a distance with reflected light. This system enjoys high measuring accuracy and allows quick focusing, but has problems such as an increase in cost due to the external distance measuring sensor, poor accuracy in focusing on an actual image, and lack of latitude with respect to a distance measuring point.

Further, in recent years, small-size digital cameras (hereinafter also referred to as “compact digital cameras”) have adopted a contrast method in which a camera sensor also operates as an autofocus (AF) sensor. The contrast method does not require separately providing a distance measuring sensor.

FIG. 2 is a flowchart illustrating a focusing process according to the contrast method. Referring to FIG. 2, in step S101, the amount of edge in a predetermined region (for example, 3×3) including a pre-given detection position (also referred to as “detection point”) is calculated.

Next, in step S102, a stepper motor is driven in a forward-moving direction and a backward-moving direction to calculate a difference with the previous amount of edge in each direction, and the stepper motor is controlled in the direction of the larger amount of edge.

If the difference in the amount of edge is positive (YES in step S103), in step S104, the stepper motor is driven in that direction. If the change in the amount of edge is negative (NO in step S103), in step S105, the previous position is determined as a focus position. Thus, the contrast method is a technique to perform focusing by maximizing the amount of edge at the detection point.

Here, in the case of a binocular camera, a closer object causes parallax to be greater, thus causing a difference between the right and left AF detection points to be greater to make it more difficult to focus on the object. A description is given, with reference to FIG. 3, of this difference between detection points.

FIG. 3 is a diagram for illustrating a difference between detection points. In FIG. 3, (a) illustrates an image viewed with a left-eye camera. Referring to (a) of FIG. 3, a detection point 22 is on the circular column 2 in the center. In FIG. 3, (b) illustrates an image viewed with a right-eye camera. Referring to (b) of FIG. 3, a detection point 21 is on the circular cone 3.

If focusing is performed in this state, the right-eye camera and the left-eye camera are focused on different objects, thus causing a focus mismatch. The detection points are supposed to be set on, for example, the same circular cone 3. In this case, a detection point 23 indicated by a broken line in (a) of FIG. 3 is to be set for the left-eye camera. However, detection points are pre-given to the respective cameras at the time of their focusing, and one of the cameras is prevented from knowing an object on which the other one of the cameras is focused.

Therefore, in order to address this problem, a technique is proposed that adjusts the focusing of an optical system, which forms a first image and a second image having parallax with respect to each other alternately on an image capturing device, based only on a signal obtained from the output of the image capturing device that has captured one of the first image and the second image.

Further, there is also a technique that performs an autofocus operation with respect to a range common to two stereoscopic image capturing optical systems for using binocular parallax based on information on the optical systems.

For related art, reference may be made to, for example, the following documents:
[Patent Document 1] Japanese Laid-open Patent Publication No. 2001-148866;
[Patent Document 2] WO2004/107762;
[Patent Document 3] Japanese Laid-open Patent Publication No. 2005-173270; and
[Patent Document 4] Japanese Laid-open Patent Publication No. 8-194274

### SUMMARY

According to an aspect of the invention, an image capturing device includes a storage part containing parallax information having an amount of parallax of a first lens and a second lens correlated with an amount of first control for driving the first lens; a first focusing control part configured to control driving of the first lens to focus the first lens at a first detection position; a parallax compensation part configured to obtain, from the parallax information, the amount of parallax corresponding to the amount of the first control performed by the first focusing control part to cause the first lens to be focused, and to detect a second detection position obtained by reflecting the amount of parallax in the first detection position; and a second focusing control part configured to control driving of the second lens to cause the second lens to be focused at the second detection position detected by the parallax compensation part.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a diagram for illustrating a focus mismatch between the images of both eyes;

FIG. 2 is a flowchart illustrating a focusing process according to a contrast method;

FIG. 3 is a diagram for illustrating a difference between detection points;

FIG. 4 is a block diagram illustrating a configuration of an image capturing device according to a first embodiment;

FIG. 5 is a diagram illustrating driving difference information according to the first embodiment;

FIG. 6 is a diagram illustrating parallax information according to the first embodiment;

FIG. 7 is a block diagram illustrating a configuration of a second AF control part according to the first embodiment;

FIG. 8 is a diagram illustrating a specific example of a focusing operation according to the first embodiment;

FIG. 9 is a flowchart illustrating a focusing control operation according to the first embodiment;

FIG. 10 is a block diagram illustrating a configuration of an image capturing device according to a second embodiment;

FIG. 11 is a block diagram illustrating a configuration of a parallax compensation part according to the second embodiment;

FIG. 12 is a flowchart illustrating a focusing control operation according to the second embodiment; and

FIG. 13 is a block diagram illustrating a configuration of a portable terminal device according to a third embodiment.

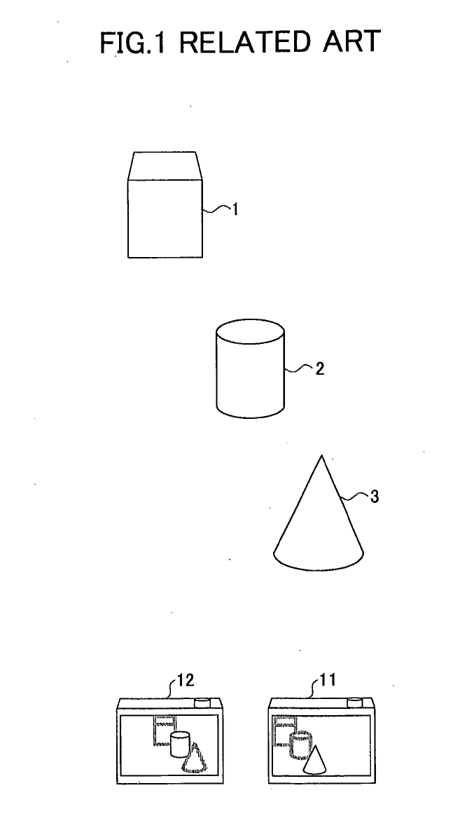

### DESCRIPTION OF EMBODIMENTS

As described above, compact digital cameras have adopted the contrast method as an autofocus technique. In the case of using the contrast method that does not provide a distance measuring sensor, according to Patent Document 3, whose system evaluates the presence or absence of focus in only one of the cameras, there is no guarantee that the other one of the cameras is focused on the object because of individual differences in motor control.

Further, according to Patent Document 4, it is possible to narrow the common range in the case of a long focal length. In the case of capturing an image of a close object, however, considering that a wide-angle lens is used instead of a zoom lens, the common range is not narrowed enough to be able to identify the object.

Thus, binocular image capturing devices that perform contrast method AF control have a problem in that there may be a focus mismatch between the images captured with multiple optical systems because one of the optical systems is prevented from knowing the position of an object on which the other one of the optical systems is focused.

According to an aspect of the present invention, it is possible to perform proper AF control that prevents occurrence of a focus mismatch between optical systems in binocular image capturing devices.

According to an aspect of the present invention, an image capturing device and an image capturing control method are provided that enable proper AF control that prevents occurrence of a focus mismatch between optical systems.

Preferred embodiments of the present invention will be explained with reference to accompanying drawings.

### [a] First Embodiment

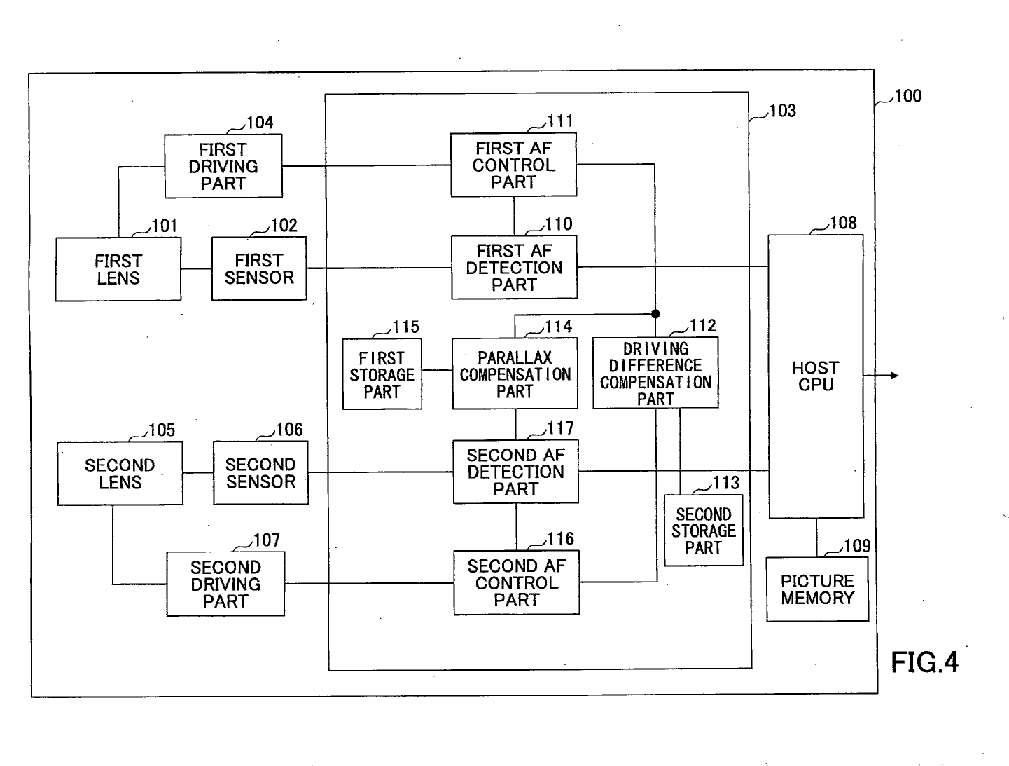

FIG. 4 is a block diagram illustrating a configuration of an image capturing device 100 according to a first embodiment.

Referring to FIG. 4, the image capturing device 100 according to the first embodiment includes a first lens 101, a first sensor 102, a signal processing part 103, a first driving part 104, a second lens 105, a second sensor 106, a second driving part 107, a host central processing unit (CPU) 108, and a picture memory 109, which are interconnected via a bus in such a manner as to allow data to be transmitted to and received from one another.

The first lens 101 is driven by the first driving part 104. The first sensor 102 generates image data corresponding to an image received by the first lens 101. Examples of the first sensor 102 include a charge-coupled device (CCD).

The signal processing part 103 performs autofocus (AF) control on the first lens 101. Further, the signal processing part 103 performs AF control on the second lens 105 described below. A description is given in detail below of the signal processing part 103. The signal processing part 103 may be implemented as, for example, a signal processing LSI.

The first driving part 104 causes the first lens 101 to move by driving a built-in lens moving device in response to a first AF control signal output from the signal processing part 103. Examples of the lens moving device include a stepper motor and a voice coil motor.

The second lens 105 is driven by the second driving part 107. The second sensor 106 generates image data corresponding to an image received by the second lens 105. Examples of the second sensor 106 include a charge-coupled device (CCD).

The second driving part 107 causes the second lens 105 to move by driving a built-in lens moving device in response to a second AF control signal output from the signal processing part 103.

The host CPU 108, for example, controls the image capturing menu of the image capturing device 100, attaches a header to image data, and performs overall control of the image capturing device 100. Further, the host CPU 108 outputs processed image data to the picture memory 109, and transmits processed image data using a transmission path. The picture memory 109 stores image data output from the host CPU 108. The picture memory 109 stores, for example, stereoscopic images.

Next, a description is given of the signal processing part 103. The signal processing part 103 includes a first AF detection part 110, a first AF control part 111, a driving difference compensation part 112, a second storage part 113, a parallax compensation part 114, a first storage part 115, a second AF control part 116, and a second AF detection part 117. In the following description of embodiments, the “first” side control (control on the side of the first lens 101, the first sensor 102, the first driving part 104, the first AF detection part 110, and the first AF control part 111) is master control.

The first AF detection part 110 detects high-frequency integrated data at a first detection position (first detection point) based on image data obtained (received) from the first sensor 102. The integrated data are output to the first AF control part 111. The first AF detection part 110 outputs the image data obtained from the first sensor 102 to the host CPU 108 as, for example, image data for the right eye (right-eye image data).

The first AF control part 111 performs an operation on the integrated data obtained (received) from the first AF detection part 110, and determines the direction of movement and the amount of movement of the first lens 101. The first AF control part 111 outputs the determined direction of movement and amount of movement to the first driving part 104, the driving difference compensation part 112, and the parallax compensation part 114 as the first AF control signal. The first AF control signal may be, for example, drive pulses indicating the number of steps if the first driving part 104 is a stepper motor, or control pulses if the first driving part 104 is a voice coil motor.

The driving difference compensation part 112 compensates for the differences of individual motors. Motor control differs depending on motors. Therefore, these differences are absorbed (compensated for). In the case of obtaining (receiving) the first AF control signal from the first AF control part 111, the driving difference compensation part 112 obtains the amount of control for the second lens 105, referring to driving difference information contained in the second storage part 113.

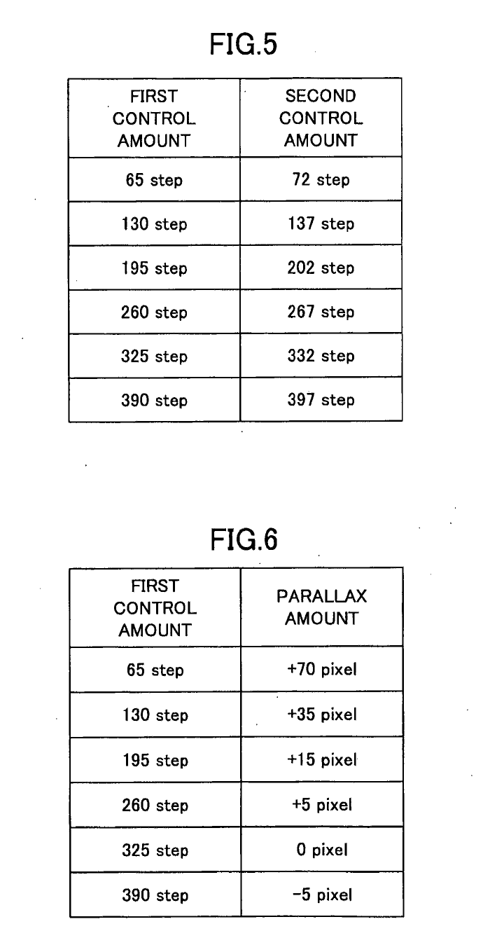

FIG. 5 is a diagram illustrating driving difference information. The driving difference information may be, for example, a driving difference compensation table retaining the values of the amounts of control of motor driving for compensating for differences in motor control as illustrated in FIG. 5. The driving difference information, for example, correlates the amounts of control for driving the first lens 101 and the amounts of control for driving the second lens 102 in order to cause the focal lengths of the first lens 101 and the second lens 102 to be equal. In FIG. 5, the “first control amount” (FIRST CONTROL AMOUNT) indicates the amounts of control for the first lens 101 and the “second control amount” (SECOND CONTROL AMOUNT) indicates the amounts of control for the second lens 105.

The driving difference compensation part 112 obtains (determines) the second control amount corresponding to the first control amount indicated by the first AF control signal, referring to the driving difference information contained in the second storage part 113. The driving difference compensation part 112 outputs the obtained second control amount to the second AF control part 116.

The parallax compensation part 114 compensates for parallax between the first lens 101 and the second lens 105. The parallax compensation part 114 obtains (receives) the first AF control signal from the first AF control part 111. Next, the parallax compensation part 114 obtains (determines) the amount of parallax corresponding to the amount of control indicated by the first AF control signal, referring to the parallax information contained in the first storage part 115.

FIG. 6 is a diagram illustrating parallax information. The parallax information may be, for example, a parallax compensation table correlating the amount of parallax of the first lens 101 and the second lens 105 with the amount of control for driving the first lens 101 (the first control amount) as illustrated in FIG. 6. The amount of control for driving the first lens 101 from a position (initial value) up to where the first lens 101 is focused is an amount corresponding to the distance between the image capturing device 100 and an object. The parallax information is the value of binocular parallax in the distance determined by advance learning. The binocular parallax in the distance may be determined by triangulation based on the interval between the right and left optical systems and the object.

In the case illustrated in FIG. 6, it is assumed that the right image and the left image have been made horizontal relative to each other and there is no offset in a vertical direction (vertical offset) between the right image and the left image, so that only the horizontal parallax is indicated using the number of pixels. If there is a vertical offset, a correction for the vertical offset of the images may be included in the parallax information.

The parallax compensation part 114 reflects the obtained amount of parallax, and detects a second detection position. For example, the parallax compensation part 114 determines the second detection position by adding the amount of parallax to the coordinates of the retained first detection position. The parallax compensation part 114 outputs the detected second detection position to the second AF detection part 117.

The second AF detection part 117 detects high-frequency integrated data at the second detection position (second detection point) based on image data obtained (received) from the second sensor 106. The integrated data are output to the second AF control part 116. The second AF detection part 117 outputs the image data obtained from the second sensor 106 to the host CPU 108 as, for example, image data for the left eye (left-eye image data).

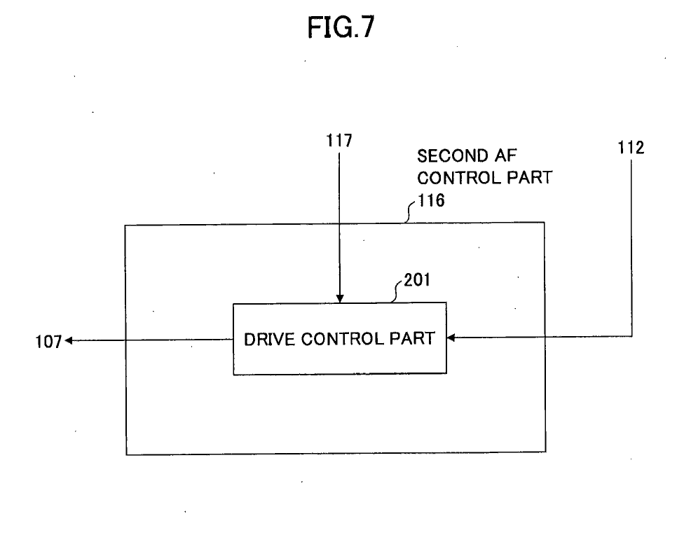

A description is given, with reference to FIG. 7, of the second AF control part 116. FIG. 7 is a block diagram illustrating a configuration of the second AF control part 116. Referring to FIG. 7, the second AF control part 116 includes a drive control part 201.

The drive control part 201 outputs the second AF control signal for the initial focusing of the second lens 105 to the second driving part 107 based on the amount of control obtained (received) from the driving difference compensation part 112. Upon completion of the initial focusing, the drive control part 201 performs an operation on the integrated data obtained (received) from the second AF detection part, and determines the direction of movement and the amount of movement of the second lens 105. The drive control part 201 outputs the determined direction of movement and amount of movement to the second driving part 107 as the second AF control signal.

That is, the second AF control part 116 uses the output data of the driving difference compensation part 112 at the time of initial focusing, and uses the output data of the second AF detection part 117 in the second and subsequent focusing control.

This makes it possible to compensate for individual motor differences to roughly eliminate an offset in initial focusing and thereafter to perform focusing with detection positions set on the same object in respective optical systems. Therefore, it is possible to perform AF control that is less likely to cause a focus mismatch between right and left image data.

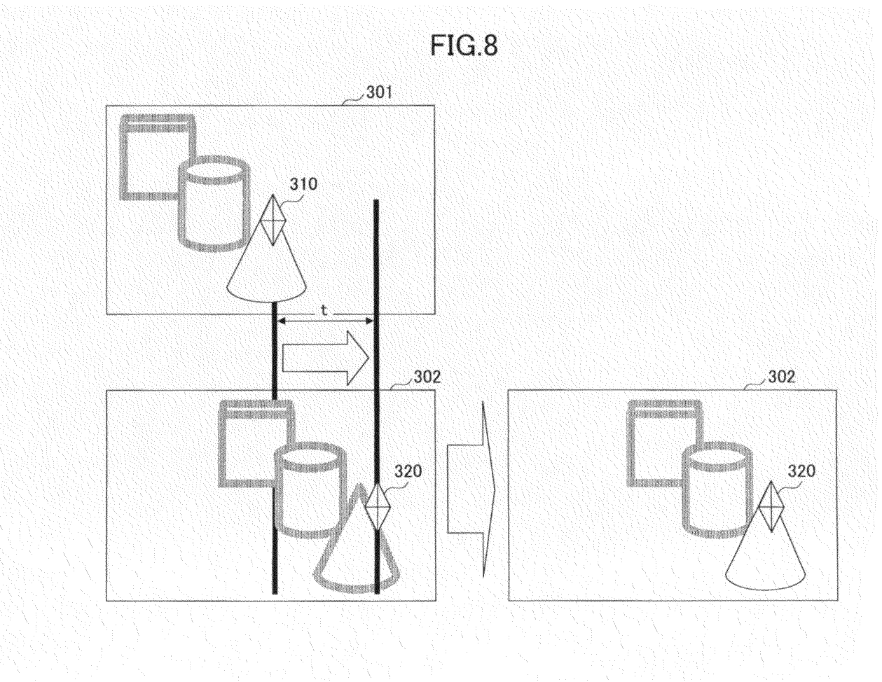

Next, a description is given of a specific example of a focusing operation. FIG. 8 is a diagram illustrating a specific example of a focusing operation. In FIG. 8, it is assumed that an image 301 is a right image and an image 302 is a left image. Here, it is assumed that the right image 301 is captured with a first optical system (including, for example, the first lens 101 and the first sensor 102) and the left image 302 is captured with a second optical system (including, for example, at least the second lens 105 and the second sensor 106).

Referring to FIG. 8, it is assumed that the coordinates of a first detection position 310 are pre-given and that focusing is performed in the circular cone part of the right image 301 based on the AF control of the first AF control part 111. The amount of movement of the first lens 101 due to the first driving part 104 at this point corresponds to a distance (over which the first lens 101 is caused to move). The amount of movement due to the first driving part 104 (along with the direction of movement of the first lens 101) corresponds to the amount of control of the first AF control part 111. The parallax compensation part 114 obtains (reads) a parallax amount t (positional offset t) corresponding to this amount of control from the parallax information (FIG. 6).

A second detection position 320 in the left image 302 may be determined by adding this offset t to the first detection position 310 in the right image 301. The second AF control part 116 controls focusing at the second detection position 320 thus determined, so that the blurry circular cone is brought into focus.

Next, a description is given of an operation of the image capturing device 100 according to the first embodiment.

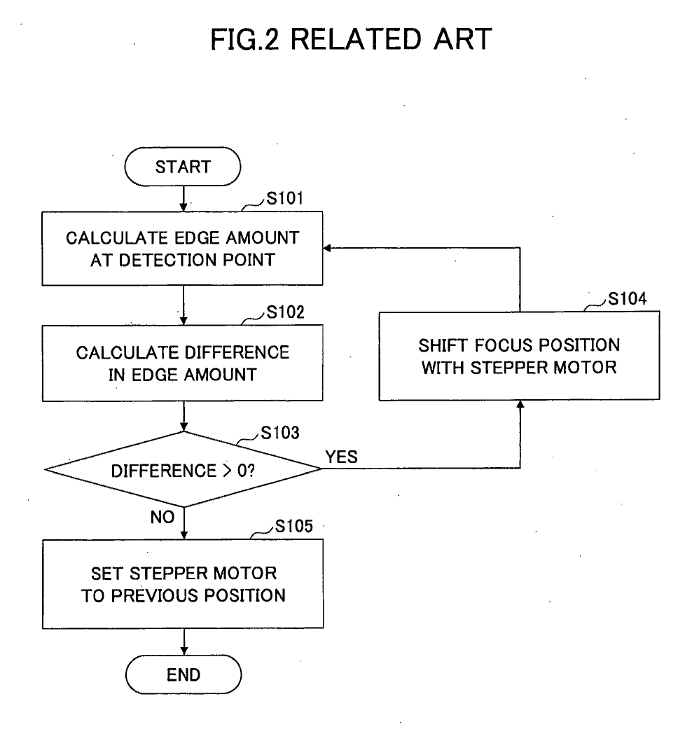

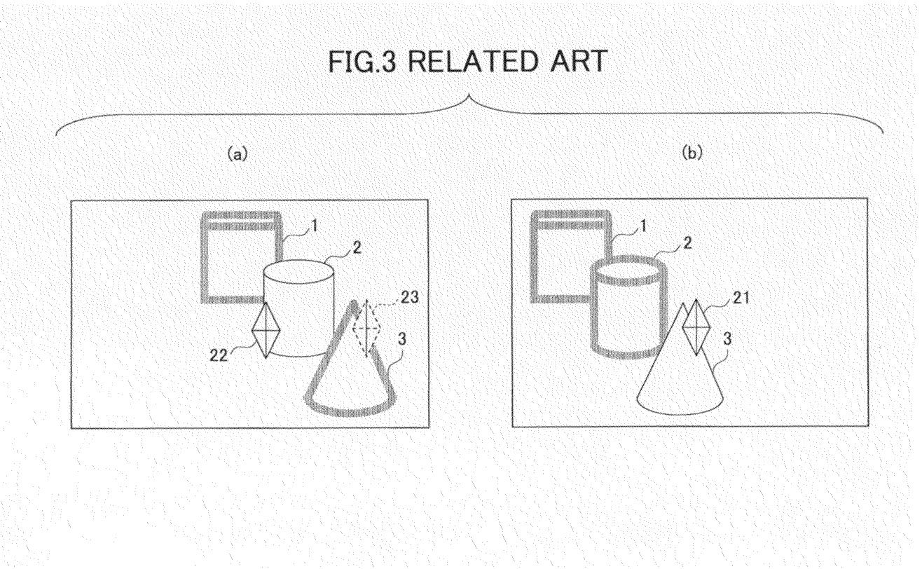

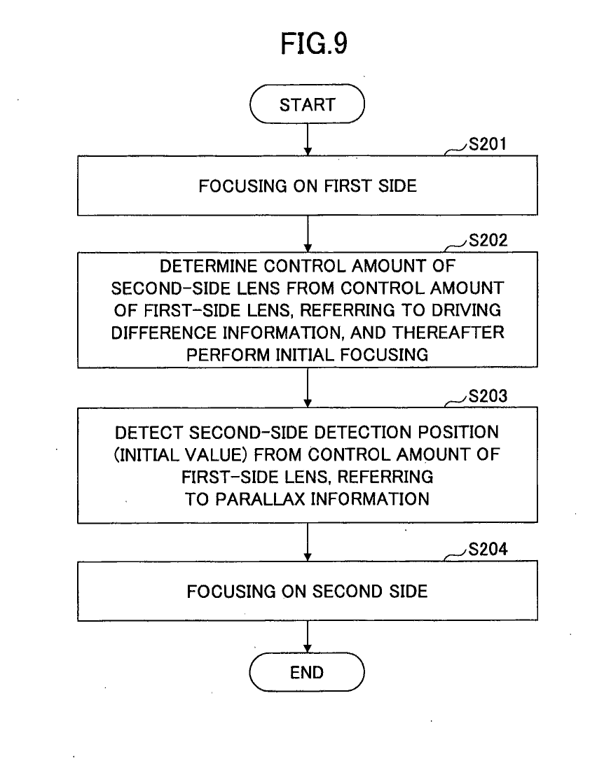

FIG. 9 is a flowchart illustrating a focusing control operation according to the first embodiment. Referring to FIG. 9, in step S201, the first AF detection part 110, the first AF control part 111, etc., perform focusing at the first detection position of image data captured through the first lens 101. The focusing is the same as the operation illustrated in FIG. 2.

In step S202, the driving difference compensation part 112 obtains the first AF control signal, and obtains the amount of control for the second lens 105, referring to the driving difference information. As a result, the amount of initial control for driving the second lens 105 is determined, so that initial focusing is performed.

In step S203, the parallax compensation part 114 obtains the first AF control signal, and obtains the amount of parallax, referring to the parallax information. The parallax compensation part 114 detects the second detection position by reflecting this amount of parallax in the first detection position.

In step S204, the second AF detection part 117, the second AF control part 116, etc., perform focusing at the second detection position of image data captured through the second lens 105. The focusing is the same as the operation illustrated in FIG. 2.

Thus, according to the first embodiment, it is possible to compensate for individual motor differences to roughly eliminate an offset in initial focusing and thereafter to perform focusing with detection positions set on the same object in respective optical systems. Therefore, it is possible to perform AF control that is less likely to cause a focus mismatch between right and left image data.

### [b] Second Embodiment

Next, a description is given of an image capturing device 400 according to a second embodiment. In the second embodiment, it is possible to more finely determine the second detection position by correcting the second detection position by performing block matching using right and left image data after detecting the second detection position by reflecting the amount of parallax in the first detection position.

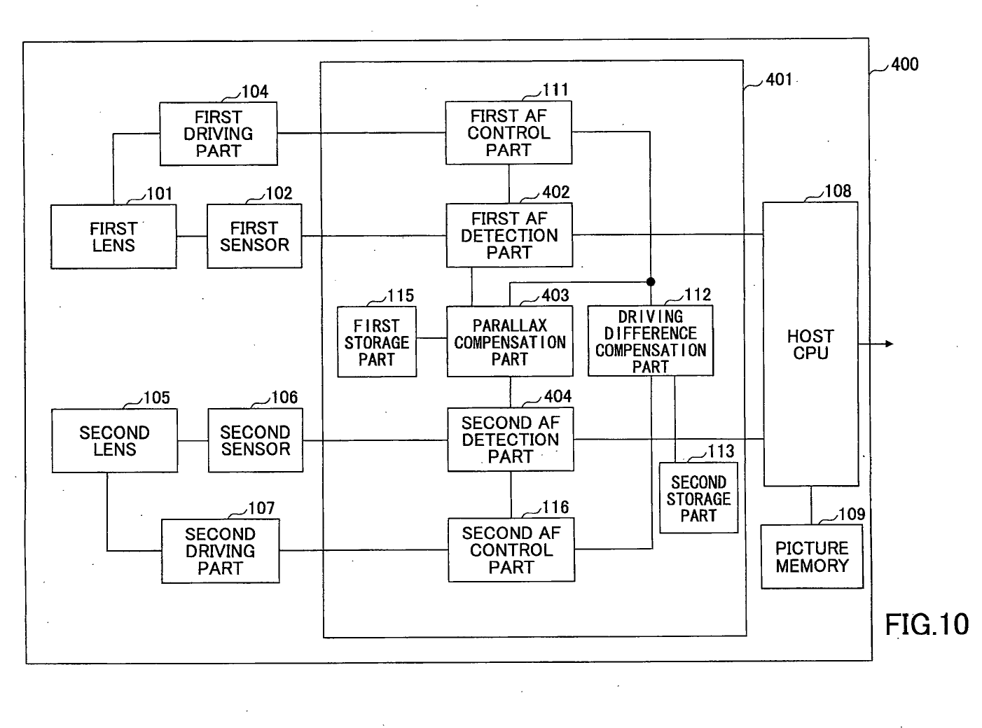

FIG. 10 is a block diagram illustrating a configuration of the image capturing device 400 according to the second embodiment. In the configuration illustrated in FIG. 10, the same elements as those of the configuration illustrated in FIG. 4 are referred to by the same reference numerals, and a description thereof is omitted. The image capturing device 400 illustrated in FIG. 10 is different from the image capturing device 100 of the first embodiment in the configuration of the signal processing part. A description is given below of a signal processing part 401 of the image capturing device 400.

Referring to FIG. 10, the signal processing part 401 includes a first AF detection part 402, the first AF control part 111, the driving difference compensation part 112, the second storage part 113, a parallax compensation part 403, the first storage part 115, the second AF control part 116, and a second AF detection part 404.

The first AF detection part 402 detects high-frequency integrated data at a first detection position (first detection point) based on image data obtained (received) from the first sensor 102. The integrated data are output to the first AF control part 111. The first AF detection part 402 outputs the image data obtained from the first sensor 102 to the host CPU 108 and the parallax compensation part 403 as, for example, image data for the right eye (right-eye image data). At this point, the first AF detection part 402 may output in-focus image data (obtained when or after the first lens 101 is focused).

The second AF detection part 404 detects high-frequency integrated data at a second detection position (second detection point) based on image data obtained (received) from the second sensor 106. The integrated data are output to the second AF control part 116. The second AF detection part 404 outputs the image data obtained from the second sensor 106 to the host CPU 108 and the parallax compensation part 403 as, for example, image data for the left eye (left-eye image data).

At this point, the second AF detection part 404 may output image data after initial focusing to the parallax compensation part 403 and output in-focus image data (obtained when or after the second lens 105 is focused) to the host CPU 108. The reason for outputting image data after initial focusing to the parallax compensation part 403 is that matching (a matching operation) described below may not be properly performed unless the image data are cleared to a certain degree of out-of-focus blur. Accordingly, it is preferable to use image data after initial focusing, in which the driving difference between the first driving part 104 and the second driving part 107 are compensated for.

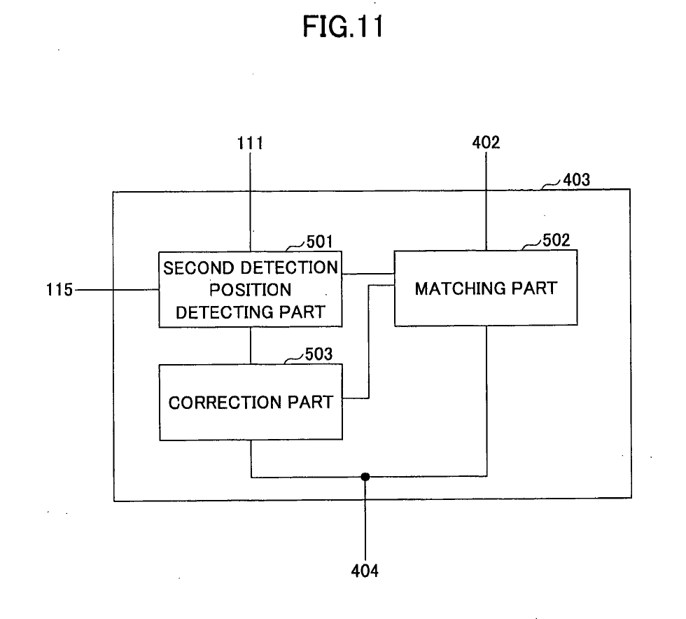

A description is given, with reference to FIG. 11, of the parallax compensation part 403. FIG. 11 is a block diagram illustrating a configuration of the parallax compensation part 403 according to the second embodiment. Referring to FIG. 11, the parallax compensation part 403 includes a second detection position detecting part 501, a matching part 502, and a correction part 503.

The second detection position detecting part 501 compensates for parallax in the first lens 101 and the second lens 105. The second detection position detecting part 501 obtains (receives) the first AF control signal from the first AF control part 111. Next, the second detection position detecting part 501 obtains (reads) the amount of parallax corresponding to the amount of control indicated by the first AF control signal, referring to the parallax information contained in the first storage part 115. The parallax information is as illustrated in FIG. 6.

The second detection position detecting part 501 reflects the amount of parallax obtained referring to the parallax information in the first detection position, and detects the second detection position. For example, the second detection position detecting part 501 determines the second detection position by adding the amount of parallax to the coordinates of the first detection position that the second detection position detecting part 501 retains. The second detection position detecting part 501 outputs the detected second detection position to the matching part 502 and the correction part 503.

The matching part 502 obtains (receives) first image data from the first AF detection part 402 and obtains (receives) second image data from the second AF detection part 404. The matching part 502 performs matching (a matching operation) on a predetermined region including the first detection position and a predetermined region in the second image data. The predetermined region in the second image data may be, for example, a predetermined region around the second detection position. This makes it possible to reduce the load of the matching operation.

A technique employed in the motion estimation of Moving Picture Experts Group (MPEG) or the like may be applied to this matching operation. The matching part 502 outputs an offset between blocks (the amount of motion), which is the matching result, to the correction part 503.

The correction part 503 corrects the second detection position obtained (received) from the second detection position detecting part 501 using the matching result obtained (received) from the matching part 502. For example, the correction part 503 moves the second detection position by the offset between blocks indicated by the matching result. The correction part 503 outputs the corrected second detection position to the second AF detection part 404.

The second AF detection part 404 detects high-frequency integrated data at the corrected second detection position. This detection is performed after initial focusing. The second AF detection part 404 outputs the detected data to the second AF control part 116.

By thus correcting the second detection position by performing block matching using the first and second image data, it is possible to more finely determine the second detection position. Further, by using image data after initial focusing as the second image data, it is possible to prevent the matching operation from being performed with a blurred image. Further, by performing block matching with a region around the second detection position, it is possible to reduce the load of the matching operation.

Next, a description is given of an operation of the image capturing device 400 according to the second embodiment.

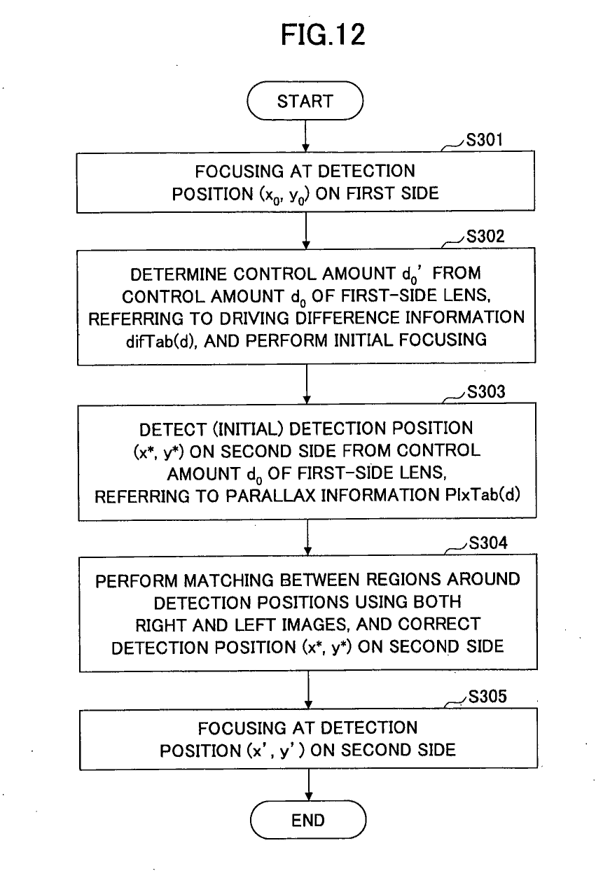

FIG. 12 is a flowchart illustrating a focusing control operation according to the second embodiment. Referring to FIG. 12, in step S301, the first AF detection part 402, the first AF control part 111, etc., perform focusing at the first detection position (x₀, y₀) of image data captured through the first lens 101. The focusing is the same as the operation illustrated in FIG. 2.

In step S302, the driving difference compensation part 112 obtains the amount of control d₀ indicated by the first AF control signal, and sets (determines) the amount of control d₀′ for the second lens 105, referring to the driving difference information difTab(d). Here, difTab(d) is a function that allows the second control amount to be determined using the first control amount d as an argument, representing the relationship illustrated in FIG. 5 as follows:

d₀′=difTab(d₀). (1)

As a result, the amount of initial control d₀′ for driving the second lens 105 is determined, so that initial focusing is performed.

In step S303, the parallax compensation part 403 obtains the amount of control d₀ indicated by the first AF control signal, and obtains the amount of parallax (x_{off}, y_{off}), referring to the parallax information PlxTab(d). In this case, the amount of parallax in a vertical direction and the amount of parallax in a horizontal direction (the amounts of offset) are set in the parallax information. Here, PlxTab(d) is a function that allows the amount of parallax to be determined using the first control amount d as an argument, representing the relationship illustrated in FIG. 6 as follows:

(x_{off}, y_{off})=PlxTab(d₀) (2)

The parallax compensation part 403 determines (detects) the second detection position (x*, y*) by reflecting this amount of parallax (x_{off}, y_{off}) in the first detection position (x₀, y₀) as follows:

(x*, y*)=(x₀+x_{off}/ y₀+y_{off}). (3)

In step S304, the parallax compensation part 403 performs matching with a region around the second detection position (x*, y*) using both right and left image data, and corrects the second detection position (x*, y*) as follows:

(x′, y′)=(x*+x, y*+y), (4)

where (x, y) minimize:

Σ|P1(x*+x, y*+y)−Pr(x₀, y₀)|, (5)

where P1 represents the left image data and Pr represents the right image data.

In step S305, the second AF detection part 404, the second AF control part 116, etc., perform focusing at the corrected second detection position (x*, y*), determined by the parallax compensation part 403. The focusing is the same as the operation illustrated in FIG. 2.

The processes of steps S302 and S303 are effective in performing the matching of the right and left images in the subsequent process of step S304, and make it possible to prevent matching from being performed with a totally out-of-focus image. Further, these processes also make it possible to reduce the amount of computation and to prevent a matching error.

Thus, according to the second embodiment, it is possible to more finely determine the second detection position by correcting the second detection position by performing block matching using the first and second image data. Further, by using image data after initial focusing as the second image data, it is possible to prevent the matching operation from being performed with a blurred image. Further, by performing block matching with a region around the second detection position, it is possible to reduce the load of the matching operation.

Further, with respect to two AF control operations that do not match in characteristics, focusing may be performed first in one of the AF control operations, and focusing may be roughly performed in the other one of the AF control operations, using the amount of control of a driving part up to focusing in the one of the AF control operations, at the time of performing the other one of the AF control operations. Thereafter, focusing may be finely performed in the other one of the AF control operations. At this point, the amount of correction obtained in the process of matching may be fed back to the parallax information as illustrated in FIG. 6 to be reflected in the parallax information.

In the first embodiment and the second embodiment, a description is given taking a twin-lens camera as an example. However, the above disclosure may also be applied to a device with three or more cameras (optical systems).

### [c] Third Embodiment

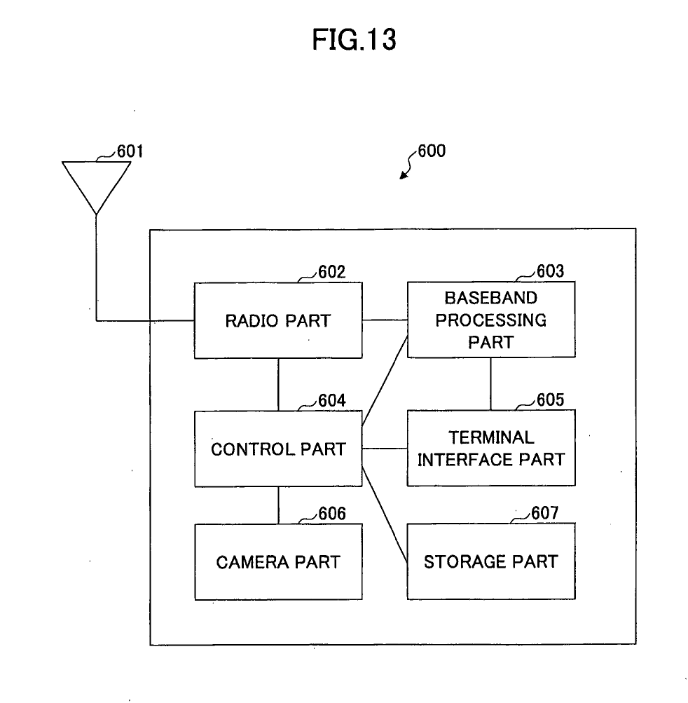

FIG. 13 is a block diagram illustrating a configuration of a portable terminal device 600 according to a third embodiment. Referring to FIG. 13, the portable terminal device 600, which may be, for example, a cellular phone, includes an antenna 601, a radio part 602, a baseband processing part 603, a control part 604, a terminal interface part 605, a camera part 606, and a storage part 607.

The antenna 601 transmits a radio signal amplified by a transmission amplifier, and receives a radio signal from a base station. The radio part 602 performs digital-to-analog (D/A conversion) on a transmission signal spread in the baseband processing part 603, converts the D/A-converted signal into a high-frequency signal by orthogonal modulation, and amplifies the high-frequency signal with a power amplifier. The radio part 602 amplifies a received radio signal, performs analog-to-digital (A/D) conversion on the received radio signal, and transmits the A/D-converted signal to the baseband processing part 603.

The baseband processing part 603 performs baseband processing including addition of an error correction code to transmission data, data modulation, spread spectrum modulation, de-spreading of a received signal, determination of a reception environment, threshold determination of each channel signal, and error correction decoding.

The control part 604 performs radio control including transmission and reception of control signals. The terminal interface part 605 performs an adapter operation for data and interfaces between the handset and an external data terminal.

The camera part 606 may corresponds to the first lens 101, the first sensor 102, the signal processing part 103, the first driving part 104, the second lens 105, the second sensor 106, and the second driving part 107. The camera part 606 may also correspond to the first lens 101, the first sensor 102, the signal processing part 403, the first driving part 104, the second lens 105, the second sensor 106, and the second driving part 107.

The storage part 607 including, for example, a ROM, a RAM, etc., may contain a program for implementing the focusing control operation described above in the first embodiment and/or the second embodiment. The control part 604 reads and executes the program to implement the focusing control operation described above in the first embodiment and/or the second embodiment.

Further, the program for implementing the focusing control operation described above in the first embodiment and/or the second embodiment may be recorded in a recording medium, which allows a. computer to execute the processing in the first embodiment and/or the second embodiment.

Further, the above-described focusing control operations may be executed by causing a computer or a portable terminal device to read the recording medium in which the above-described program is recorded. Examples of the recording medium may vary in kind, and include recording media in which information is optically, electrically, or magnetically recorded, such as CD-ROMs, flexible disks, and magneto-optical disks, and semiconductor memories in which information is electrically recorded, such as ROMs and flash memories. Further, each of the signal processing parts 103 and 401 of the above-described embodiments may be implemented in one or more semiconductor integrated circuits.

The above-described embodiments may be applied to compact digital cameras, cellular phones, and devices including multiple cameras (optical systems) and a signal processing part. Further, some or all of the elements of the above-described embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. An image capturing device, comprising:
a storage part containing parallax information having an amount of parallax of a first lens and a second lens correlated with an amount of first control for driving the first lens;
a first focusing control part configured to control driving of the first lens to focus the first lens at a first detection position;
a parallax compensation part configured to obtain, from the parallax information, the amount of parallax corresponding to the amount of the first control performed by the first focusing control part to cause the first lens to be focused, and to detect a second detection position obtained by reflecting the amount of parallax in the first detection position; and
a second focusing control part configured to control driving of the second lens to cause the second lens to be focused at the second detection position detected by the parallax compensation part.

2. The image capturing device as claimed in claim 1, wherein the parallax compensation part is configured to perform matching of a first image captured through the first lens and a second image captured through the second lens and to correct the second detection position based on a result of the matching.

3. The image capturing device as claimed in claim 2, further comprising:
an additional storage part containing driving difference information correlating the amount of the first control for driving the first lens and an amount of second control for driving the second lens for causing a focal length of the first lens and a focal length of the second lens to be equal; and
a driving difference compensation part configured to obtain, from the driving difference information, the amount of the second control for driving the second lens corresponding to the amount of the first control performed by the first focusing control part to cause the first lens to be focused,
wherein the second focusing control part is configured to control the driving of the second lens based on the amount of the second control obtained by the driving difference compensation part, and thereafter to control the driving of the second lens to cause the second lens to be focused at the second detection point.

4. The image capturing device as claimed in claim 3, wherein the second image is captured through the second lens after the second focusing control part controls the driving of the second lens based on the amount of the second control obtained by the driving difference compensation part.

5. The image capturing device as claimed in claim 2, wherein the parallax compensation part is configured to perform the matching between a region including the first detection position in the first image and a region around the second detection position in the second image.

6. An image capturing control method, comprising:
controlling driving of a first lens to focus the first lens at a first detection position;
obtaining, from parallax information having an amount of parallax of the first lens and a second lens correlated with an amount of first control for driving the first lens, the amount of parallax corresponding to the amount of the first control performed to cause the first lens to be focused;
detecting a second detection position obtained by reflecting the amount of parallax in the first detection position; and
controlling driving of the second lens to cause the second lens to be focused at the detected second detection position.
